(19) United States
(12) Patent Application Publication
(10) Pub. No.: US 2014/0143120 A1
(43) Pub. Date: May 22, 2014

(54) METHOD FOR ESTABLISHING INVESTMENT TRANSACTIONS USING SECOND SCREEN TECHNOLOGY AND A COMPUTER NETWORK SYSTEM EMPLOYING SAME

(71) Applicant: BUSINESS INSTINCTS GROUP INC., Calgary (CA)

(72) Inventors: Jamie CLARKE, Calgary (CA); Paul READWIN, Calgary (CA); Cameron CHELL, Calgary (CA); Erika RACICOT, Calgary (CA)

(73) Assignee: BUSINESS INSTINCTS GROUP INC., Calgary (CA)

(21) Appl. No.: 14/086,719

(22) Filed: Nov. 21, 2013

Related U.S. Application Data
(60) Provisional application No. 61/729,390, filed on Nov. 22, 2012.

(51) Int. Cl. G06Q 40/00

(52) U.S. Cl. CPC G06Q 40/04
USPC 705/37

(57) ABSTRACT

A method and a computer network system for establishing a transaction for transferring security shares in exchange of capital investment via the use of second screen technology is disclosed. The system synchronizes a plurality of client computing devices by periodically sending thereto a notification regarding a television program about a fund-seeking company currently in broadcast. An investment user registered with the system may use the client computing device to obtain further information regarding the fund-seeking company while watching the television program, and complete a transaction to acquire shares thereof.

### FIELD OF THE DISCLOSURE

The present disclosure generally relates to a method and a computer network system for establishing investment transactions, and in particular, relates to a method and a computer network system for establishing a transaction of transferring security shares in exchange of capital investment via the use of second screen technology.

### BACKGROUND OF THE DISCLOSURE

Fundraising and capital investment methods are known. For example, traditionally, a company seeks capital investment by presenting all business related materials and legally required investment documents to investors, who usually are a small number of people and financial institutes. As a result, investors are often inundated with business plans, financial and legal documents. The process of establishing a transaction of capital investment between an investor and a fundraiser is usually lengthy and time consuming.

Recently, crowdfunding has emerged, and has garnered significant momentum and public awareness. Crowdfunding refers to raising funds for a company or a project from a large number of potential investors, who often are ordinary individuals. An investor may choose to invest a small amount of money in exchange of, e.g., a recognition, a gift, a trial product or the like. Alternatively, an inventor may choose to invest a large amount of money in exchange for a security share of the company, a discount in purchasing products, a privilege, a high-rank title, or the like.

With the emerging of government-approved crowdfunding platforms, there is a new option open to investors who wish to invest in private companies, and in particular, startup companies. These crowdfunding platforms provide crowdfunding portals to guide fundraisers, for example, for a fund-seeking company to post a fundraising request thereon in compliance with funding guidelines as laid out by government legislation. Investors, on the other hand, may use the crowdfunding portal to find companies or projects in which to invest. However, most of these portals only provide limited information of the fundraisers, and support limited interaction between investors and fundraisers.

With the progress of government financial regulation and legislation, including the progress of American financial regulation and legislation, the ability to invest in private securities is becoming available to a previously unprecedented amount of people. Therefore, there is a need to facilitate these investors to access information of private securities they want to invest, and provide methods needed to facilitate investment transactions with private companies.

### SUMMARY OF THE DISCLOSURE

According to one aspect, this disclosure discloses a computerized method for establishing a transaction for transferring security shares in exchange of payment between a first user and a second user, said method comprising:

storing at least one first document relevant to a business plan of the first user;

broadcasting a video clip describing said business plan as a television program according to a predetermined broadcast schedule;

synchronizing, at the time said video clip is broadcasting, a computing device of the second user with the video clip on broadcast;

in response to a request received from the computer device of the second user, authenticating the second user and determining the eligibility of the second user based on predefined criteria;

transmitting at least one of the at least one first document to the computer device of the second user;

receiving, from second user, a request for the acquisition of security shares offered from the first user, at least one document having a signature of the second user and a payment;

establishing a transaction between the first and second users for transferring security shares from the first user to the second user and for transferring payments from the second user to the first user.

According to another aspect, this disclosure discloses a computer system for establishing a transaction for transferring security shares in exchange of payment between a first user and a second user, said system comprising:

at least one server;

at least one storage functionally coupling to said server;

a plurality of client computing devices functionally coupling to said server; said server executing computer readable code for

storing, in said storage, at least one first document relevant to a business plan of the first user;

storing, in said storage, a broadcast schedule of a video clip broadcasting in a television channel as a television program;

synchronizing, at the time said video clip is broadcasting, a client computing device of the second user with the video clip on broadcast;

in response to a request received from the client computer device of the second user, authenticating the second user and determining the eligibility of the second user based on predefined criteria;

transmitting, from said storage, at least one of the at least one first document to the client computer device of the second user;

receiving, from second user, a request for the acquisition of security shares offered from the first user, at least one document having a signature of the second user and a payment;

establishing a transaction between the first and second users for transferring security shares from the first user to the second user and for transferring payments from the second user to the first user.

According to yet another aspect, this disclosure discloses a computerized method for establishing a transaction for transferring security shares in exchange of payment between a first user and a second user, said method comprising:

storing at least one first document relevant to a business plan of the first user;

storing a broadcast schedule of a video clip broadcasting in a television channel as a television program;

synchronizing, at the time said video clip is broadcasting, a computing device of the second user with the video clip on broadcast;

in response to a request received from the computer device of the second user, authenticating the second user and determining the eligibility of the second user based on predefined criteria;

transmitting at least one of the at least one first document to the computer device of the second user;

receiving, from second user, a request for the acquisition of security shares offered from the first user, at least one document having a signature of the second user and a payment;

establishing a transaction between the first and second users for transferring security shares from the first user to the second user and for transferring payments from the second user to the first user.

According to still another aspect, this disclosure discloses a computer-readable storage device comprising computer-executable instructions for establishing a transaction for transferring security shares in exchange of payment between a first user and a second user, wherein the instructions, when executed, cause at lease one processor to perform actions comprising:

storing at least one first document relevant to a business plan of the first user;

storing a broadcast schedule of a video clip broadcasting in a television channel as a television program;

synchronizing, at the time said video clip is broadcasting, a computing device of the second user with the video clip on broadcast;

in response to a request received from the computer device of the second user, authenticating the second user and determining the eligibility of the second user based on predefined criteria;

transmitting at least one of the at least one first document to the computer device of the second user;

receiving, from second user, a request for the acquisition of security shares offered from the first user, at least one document having a signature of the second user and a payment;

establishing a transaction between the first and second users for transferring security shares from the first user to the second user and for transferring payments from the second user to the first user.

According to another aspect of this disclosure, a system and method is disclosed herein for investors to acquire private securities with the use of second screen technology enabled client computing devices, which are preferably mobile devices, such as smart phones and tablets.

The system synchronizes client computing devices with one or more fund seeking company related television programs currently in broadcasting, and allows investment users, while watching the television program, to view further information thereabout as they want. The system also allows investment users to securely purchase private securities of the fund-seeking companies through a secure database server by logging-in to a secured web application. The process for both investors and fund-seeking companies to establish investment transaction is thus simplified.

According to one aspect of this disclosure, investment users of the system, while watching a television program regarding a fund-seeking company, are able to use their client computing device to select a desired fund-seeking company and access more in depth information thereabout, as well as find investment documents that can be signed and submitted to the system for establishing a transaction for acquiring shares of the desired fund-seeking company. Through a application using well established web technology, investment users, after their identities are authenticated, are able to make capital investments for securities into corporations or businesses at their own convenience, streamlining the crowdfunding and traditional private investment markets into an online, second screen experience.

According to another aspect of this disclosure, the system authenticates a user's identity by verifying at least some of the user's user name, password, investment or fund-seeking history, full name, phone number, email, billing address, occupation and the like.

According to yet another aspect of this disclosure, the system also verifies the eligibility of an investment user, e.g., the user's financial eligibility, in accordance with predetermined government regulations and legislation, when the investment user wants to access more information regarding a desired fund-seeking company.

After identity authentication and eligibility verification, an investment user is directed to a summary page, which comprises all the necessary corporate and legal documents related to the desire fund-seeking company. The investment user is then able to read and download the documents. The investment user is also able to digitally sign necessary documents for acquiring security shares of the desired fund-seeking company. Alternatively, the investment user is also allowed to submit a scanned copy of manually signed documents for acquiring security shares of the desired fund-seeking company. The system automatically verifies the investment user's signature by verifying the digital signature (if digitally signed), or by comparing the image of the signature with the investment user's signature stored in the system.

Once the information and documentation has been signed, the investment user is redirected to a transaction server where credits, such as capital investment or money, required for acquiring shares is processed and placed into a trust account. Once the credits have been processed and cleared, the system automatically analyzes the submitted documents to verify their correctness and authenticity. Optionally, the documents and credits invested further reviewed by a legal counsel of the service provider of the system. Once reviewed and approved, a share certificate is issued to the investment user and recorded in the investment user's account in a secure database.

According to one aspect of this disclosure, there is provided a scalable method for investment users to purchase private securities directly from their mobile devices.

According to another aspect of this disclosure, there is provided a system for investment user and fund-seeking users to establish investment transactions smoothly.

According to yet another aspect of this disclosure, there is provided a system and method to monitor and verify investment transactions to ensure the compliance of legislation and regulation requirements.

According to yet another aspect of this disclosure, there is provided a purchasing system with a single software application program for synchronizing with fund-seeking company related television program, and for establishing investment transactions.

The system disclosed herein also provides functionalities to assist fund-seeking users in creating business plans and facilitating their presentation to investment users.

The system disclosed herein further provides functionalities to assist fund-seeking users in creating audio/video clips for television broadcasting.

In addition to various business plans and audio/video clips, other business data is stored in the system, which include, e.g., shareholders agreements, business plans, financial information, and capitalization tables, incorporation documents.

According to still another aspect of this disclosure, fund-seeking user's funding plans are screened prior to expose to investment users. Fund-seeking users can only make available shares of an agreed standard class.

According to still another aspect of this disclosure, the system assists investment users in facilitating their purchase of securities and in providing necessary due diligence documentation.

### BRIEF DESCRIPTION OF THE DRAWINGS

FIG. 1A illustrates a high-level hardware structure of a computer network system for establishing investment transactions according to one embodiment;

FIG. 1B illustrates a software structure of the computer network system of FIG. 1;

FIG. 2 shows company data that may be stored in a content server;

FIG. 3 is a flowchart illustrating a process of user registration and log-in for manipulating the system;

FIGS. 4A and 4B are flowcharts illustrating a process for establishing investment transactions, FIG. 4A illustrates the user's entry to the system, and FIG. 4B details the presentation and interaction of the investment user in buying securities.

FIG. 5 is a flowchart illustrating the detail of the user registration step in FIG. 3;

FIG. 6 shows a portion of an example of the digital registration form displayed on a display of the client computing device;

FIG. 7 shows an example of a client computing device displaying a broadcast notification;

FIG. 8 shows a dialog showing a message and a close-dialog handle, after an investment user taps the notification icon of FIG. 7;

FIG. 9 shows an example of the display of a client computing device displaying a summary of a fund-seeking company; and

FIG. 10 is a flowchart illustrating the detail of the transaction step in FIG. 4B.

### DETAILED DESCRIPTION

In one embodiment of the present disclosure, the system and method disclosed herein integrate television broadcast into a computer network, and leverage the second screen technology to synchronize the content or programs of television broadcasting related to companies seeking funds with that presented on client computing devices to facilitate investors in acquiring private securities. The system disclosed herein implements access control to grant different users different rights for accessing content and functionalities of the system. For example, the television programs related to fund-seeking companies may be broadcast to the public so anyone can watch, may be broadcast to the public under subscription so that only those who subscribe the programs or channels therein can watch, or may be privately broadcast to a limited number of people. On the other hand, only authenticated investment users of the system can access business data and acquire the securities. The system disclosed herein may also act as a funding portal to engage corporations and businesses with a variety of investors.

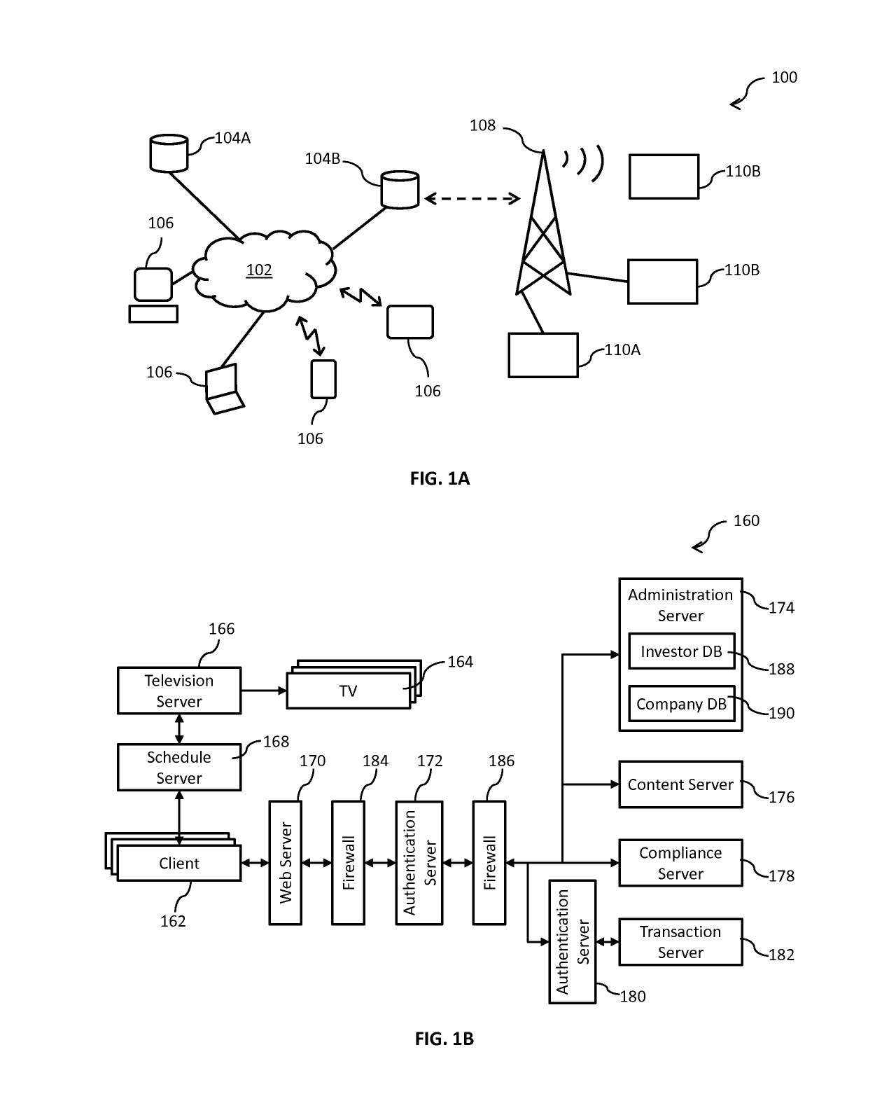

Turning to FIG. 1A, a computer system 100 is illustrated. The computer system 100 comprises a computer network 102, one or more computer servers 104A, 104B functionally connecting to the network 102, and a plurality of client computing devices 106 functionally connecting to the network 102. Here, the computer network 102 is a network for connecting computing devices, and may be a local area network (LAN), wide area network (WAN), metropolitan network (MAN), Internet, or the like. It may also be a wired or wireless communication network for connecting smart phones such as a 4G wireless communication network. As those skilled in the art appreciate, computer servers 104 and client computing devices 106 may connect to the network 102 via wired or wireless means, e.g., Ethernet, WiFi®, Bluetooth®, Zigbee®, or the like.

A computer server 104A or 104B may comprise a central processing unit (CPU), a storage such as Read-Only Memory (ROM), volatile and/or non-volatile Random Access Memory (RAM), solid state drive, hard drive, or the like, a network module, and other components, all connected to the CPU via one or more signal buses. Each computer server 104A, 104B executes an operating system, e.g., Unix®, Linux®, Microsoft® Window NT, Microsoft® Windows 2000 Server, Microsoft® Windows Server 2012 or the like. Generally, an operating system is a set of computer readable code executed by the CPU for managing various hardware and software components, and for supporting the execution of application programs.

The client computing devices 106 may be tablets, smart-phones, desktop computers, laptop computers and the like. As those skilled in the art appreciate, a client computing device 106 may comprise a CPU, a storage, a network module, an input device for receiving user input, and a display, all connected to the CPU via one or more signal buses. In one embodiment, some client computing devices 106 may comprise a touch sensitive screen for displaying output thereon and receiving user input therefrom. Each client computing device 106 executes an operating system, e.g., Microsoft® Windows®, Apple® Mac OS®, Apple® IOS™, Google Android™, Microsoft® Windows® Mobile, BlackBerry® OS, or the like. With the support of the operating system, an application program is running on the client computing device to facilitate users to seek funds or make an investment.

The computer system 100 also comprises at least one broadcast station 108 for broadcasting audio/video clips or programs to a plurality of television devices 110A and 110B via wireless or via wired means. As skilled persons in the art appreciate, the broadcast station 108 may be a television broadcast station broadcasting audio/video programs in accordance with a generally predetermined schedule to television devices 110A, 110B via free-space, satellites, and/or coaxial cable, or alternatively be a television server broadcasting audio/video programs to television devices 110A, 110B via a communication network, which may be the computer network 102 or a communication network separate from the computer network 102, depending on the implementation.

A computer server 104B is in communication with the broadcast station 108 and commands client computing devices 106 to synchronize with the schedule of at least some of the broadcasted audio/video programs related to fund-seeking companies.

FIG. 1B illustrates a software structure 160 of the computer system 100. As can be seen, from a software point of view, the system 100 comprises a plurality of software servers 166 through 182, inclusive, communicating with a plurality of client programs 162 and televisions 164, which, as those skilled in the art appreciate, may be located on the storage of one or more computer servers 104A, 104B. In particular, the system comprises a television server 166 for broadcasting audio/video clips or programs to a plurality of television devices 164. Here, the television server 166 collectively refers to the broadcast station or the aforementioned television server from a software point of view. As skilled persons in the art appreciate, the television server 166 broadcasts television programs, which are generally video clips, in one or more television channels. In each channel, the television server 166 sequentially broadcasts a plurality of video clips or programs generally in accordance with a predetermined schedule.

Generally, different channels broadcast different video clips. However, a video clip may be broadcast on a plurality of channels, at the same date and time, or at different date or time, depending on the arrangement and schedule of each channel. Some of the video clips broadcasted from the television server 168 are related to fund-seeking companies, and investors need to be informed.

The system also comprises a schedule server 168. The schedule server 168 communicates with the television server 166 for obtaining its broadcast schedule, and communicates with a plurality of client programs 162, each running on a client computing device 106, to synchronize client programs 162 with the audio/video clips broadcasted by the television server 166, the detail of which is described later.

In this embodiment, each client program 162 is a standalone program exploiting known, well established web technology. A web server 170 is provided for client programs 162 to connect for accessing various functionalities and databases. By connecting to the web server 170, a client program may connect to an authentication server 172 through a firewall 184 to authenticate the identity of the user thereof. Once the user's identity has been authenticated, the client program 162 may further connect through a firewall 186 to a plurality of servers 174 through 182, inclusive, to perform various actions.

The administration server 174 stores user profiles. In this embodiment, the system categorizes users as investment users and fund-seeking users. investment users' profiles are stored in an investor database 188, which is accessible only by the respective investor, and profiles of fund-seeking users are stored a company database 190, which is accessible only by respective companies.

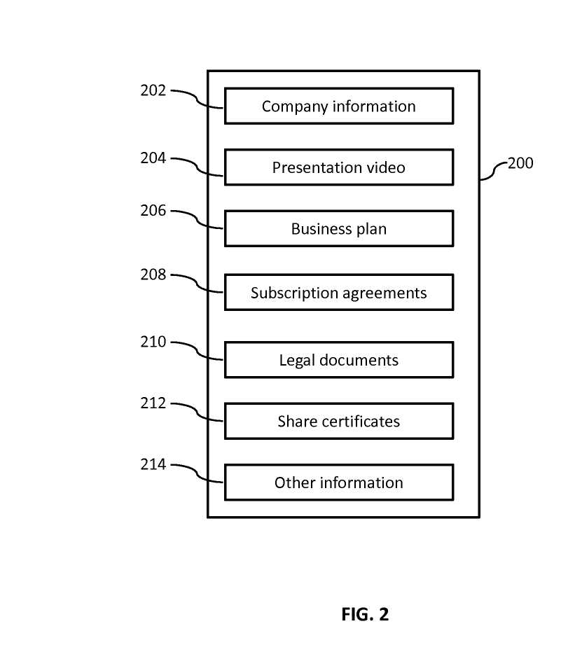

The content server 176 comprises a database for each fund-seeking user to store company data therein for presentation to investment users. FIG. 2 shows an example of the company data 200 that may be stored in the content server 176, which includes general company information 202, presentation video clips 204, business plans 206, subscription agreements 208, audio/video media files, legal documents 210 necessary for purchasing securities, share certificates 212, and other data such as audio/video media files and presentation documents, e.g., Microsoft® PowerPoint® documents.

Referring back to FIG. 1B, the compliance server 178 comprises functions for monitoring user actions, such as user registration and signing of the subscription agreements and other legal documents in the content server 176, and for verifying, in accordance with a set of predefined rules, the correctness of user-provided data including user-signed documents to ensure that user actions meet the standards and requirements of all necessary regulations and legislation.

The transaction server 182, which is accessible by client programs 162 after the users thereof have been authenticated by a second authentication sever 180, comprises functions for establishing a transaction between an investment user and a fund-seeking user (described later). During a transaction, the compliance server 178 automatically checks the company data and documents to verify whether the data and documents are compliant with a set of predefined rules such as those set by legislation. One such framework, for example, is under the Jumpstart Our Business Startups Act (JOBS Act) of the U.S. that regulates funding of small businesses in U.S.

The software servers 166 through 182, inclusive, may be deployed in one or more server computers 104A, 104B. Those skilled in the art also appreciate that the system may also comprise other servers for performance, functionality and storage purposes such as data backup, load balancing and the like.

In operation, the system 100 requires a user to first register in the system as an investment user or a fund-seeking user (e.g., a individual investor or a representative of a fund-seeking company). After registration, a fund-seeking user may submit one or more audio/video clips for television broadcasting and submit multimedia contents, e.g., audio/video clips, interactive content composed using Adobe® Flash® or HTML5, and documents such as financial and legal documents for potential investors to review. The submitted audio/video clips for television broadcasting are stored in the television server 166, and a copy thereof is also stored in the content server 176. The submitted multimedia contents and documents are stored in the content server 176. Investment users may watch the television program while their client computing devices 106 are synchronized to the schedule thereof, review selected documents of fund-seeking companies using the client computing devices 106, and establish investment transactions to acquire security shares thereof.

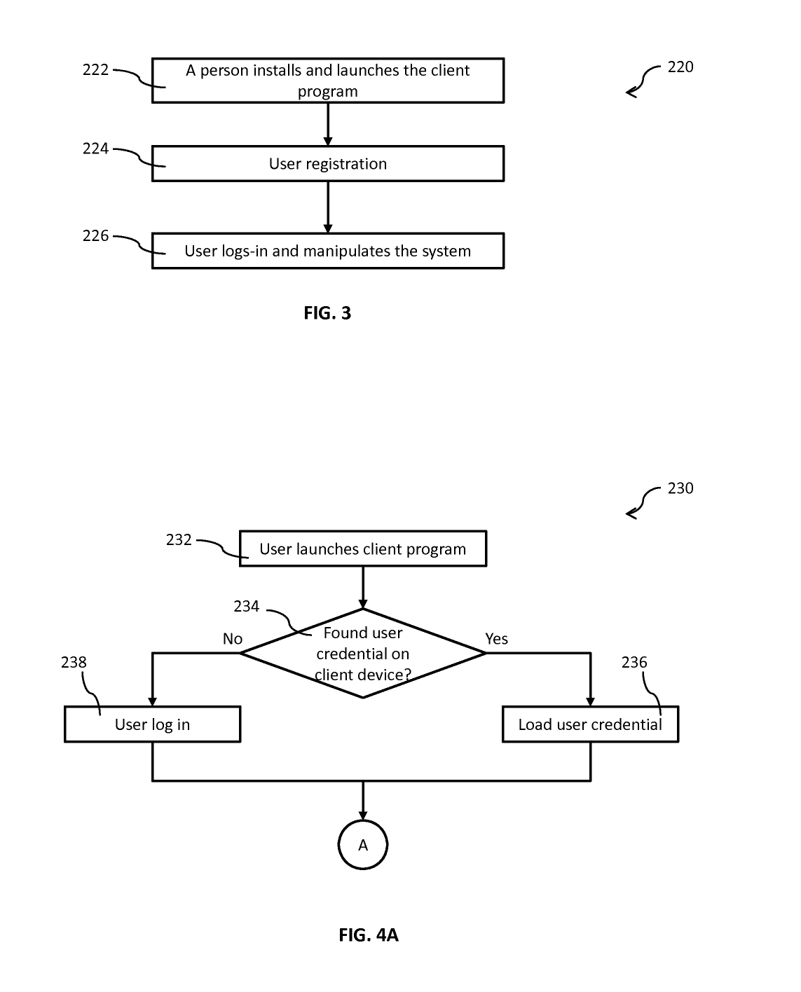

FIG. 3 is a flowchart illustrating a process 220 for manipulating the system 100. At step 222, a person wanting to be an investment user or a fund-seeking user installs the client program 162 on a computing device 106 such as a smart phone or a tablet, and launches the client program 162. The client program 162 connects to the web server 170. In response, the web server 170 communicates with the client program 162 to register the person to the system 100 as a registered user (step 224). After user registration, the user may login to and manipulate the system (step 226).

Those skilled in the art appreciate that the login and manipulation step 226 may be repeated many times as the user wants. Moreover, the order of steps 222 and 224 may be exchanged. For example, a user may register first by using a desktop computing device, and then install the client program on a smart phone for manipulating the system 100.

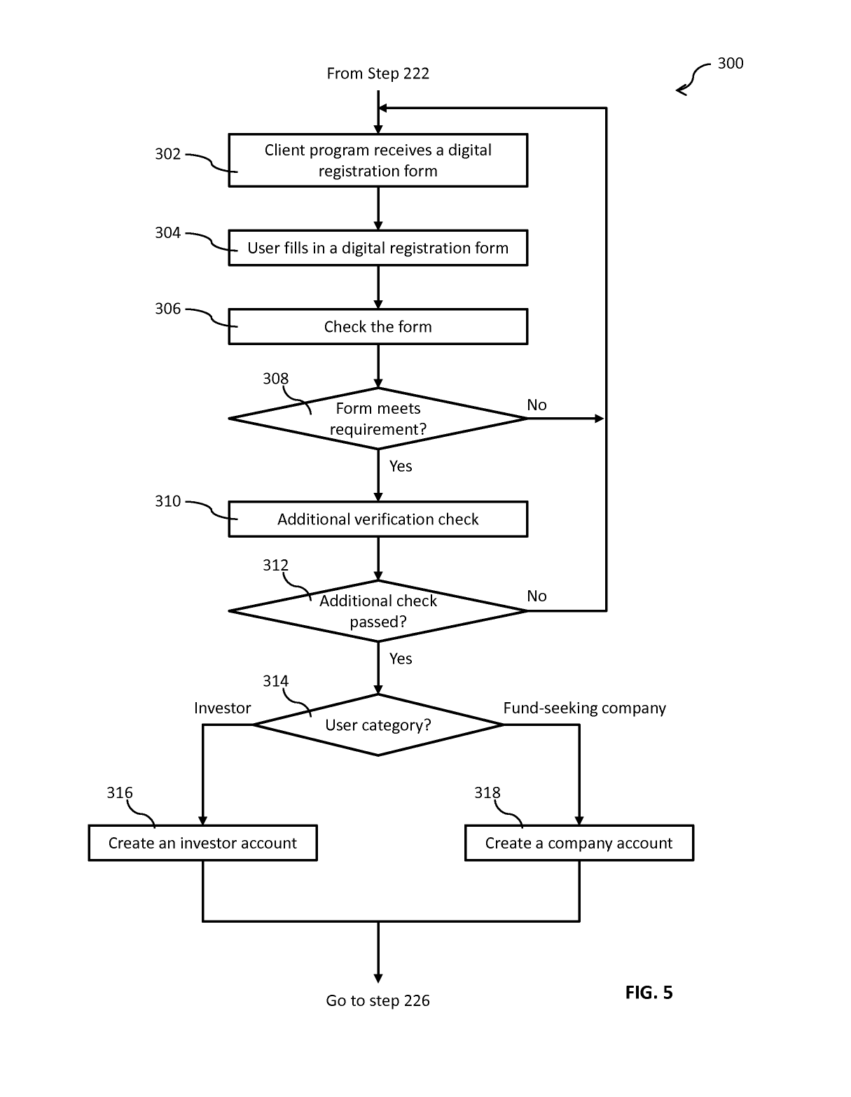

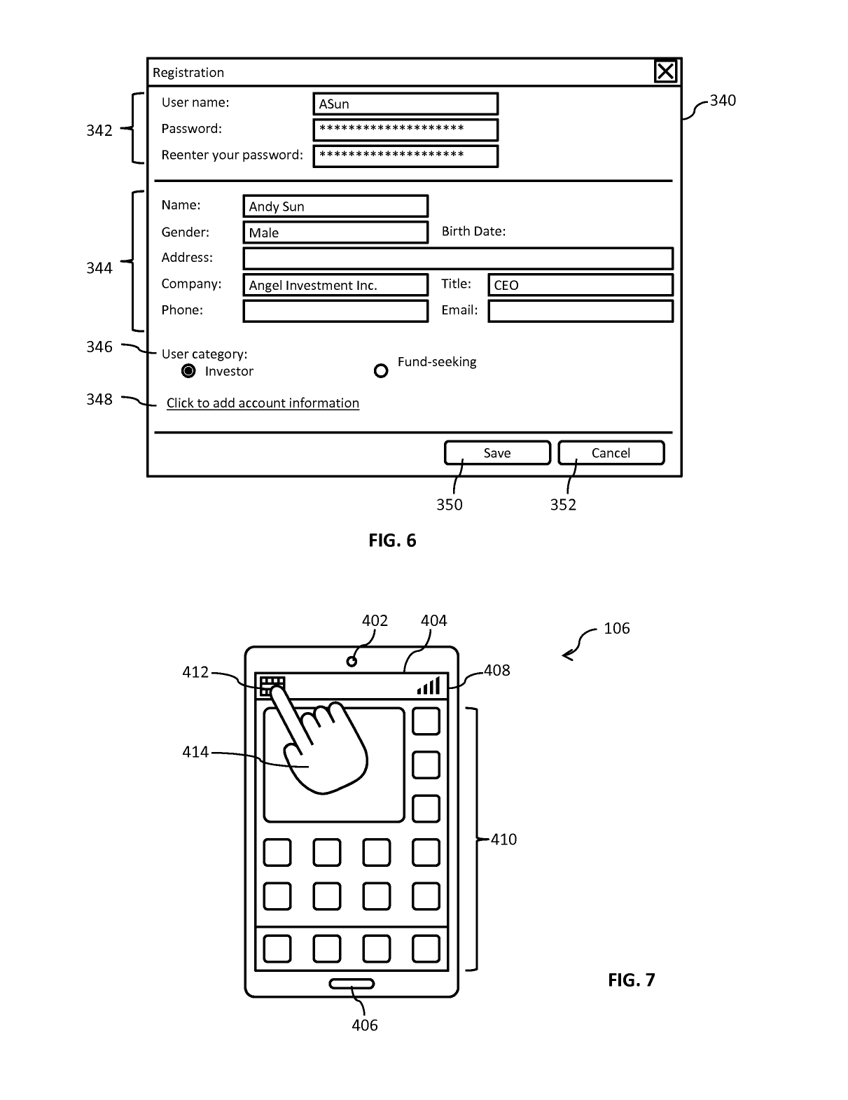

FIG. 5 illustrates, in detail 300, the user registration of step 224. As shown, the web server 170 first transmits a digital registration form to the client program 162 (step 302). The user of the client program fills in the registration form and submits it to the web server 170 (step 304). Referring to FIG. 6, a portion of an example of the digital registration form 340 is displayed on a display of the client computing device 106.

As shown in FIG. 6, the form 340 comprises fields 342 for entering a user name and password, and fields 344 for entering personal information, e.g., name, gender, birth date, address, company, title, phone number, email address and the like. The digital form 340 also comprises a user category selection 346 for choosing to be registered as an investment user or a fund-seeking user. The digital form 340 further comprises a link 348 that may be clicked or tapped to enter information of a user credit account, such as information of a bank account, a credit card account or the like, that records credits (in terms of capital investment, money, credit points or the like) and may be used during a share-acquisition transaction. The user of the client program may click or tap the “Cancel” button 352 to cancel the registration process, or click or tap the “Save” button 350 to submit the digital registration form 340.

Although not shown, the user of the client program can also register, as a part of the registration process, a signature, such as one or more of the person's signature, a seal of a company that the person is the representative thereof, or a digital signature.

Referring back to FIG. 5, after receiving the submitted registration form at step 304, the web server 170 communicates with the compliance server 178 to check if the information in the submitted form is valid, by checking if the submitted form is in compliance with security requirements and regulation and legislation requirements (step 306). For example, the compliance server 178 checks the correctness of user's name to determine if the entered name is not a real name (such as a name consisting of a repeat of the same letter, e.g., “AAAA”). The compliance server 178 also checks if the address, phone number and email address are valid, and further checks if the account information provided in the form is valid (step 308). If the compliance server 178 determines that the submitted form does not meet all requirements, the web server 170 sends the client program an warning indicating that the submitted form is invalid, and the process goes back to step 302 for the user of the client program to correct the errors and resubmit the form.

If at step 308, the compliance server 178 determines that the submitted form meets all requirements and is valid, the system further conducts an additional verification to verify the validity of information in the submitted form (step 310). For example, the compliance server 178 may automatically send an email to the email address listed in the registration form, asking the user of the client program to reply the email with a predefined title, or open a link described in the email, to verify the correctness of the email in the registration form. As another example, the compliance server 178 may automatically generate a letter for a support staff of the system 100 to mail the letter to the address listed in the registration form. The letter comprises a unique code for the person to enter to a user interface (UI) of the system to verify the address provided in the submitted registration form. Those skilled in the art appreciate that other additional verification methods may also be used to verify whether the submitted registration form is valid. If the additional verification determines that the submitted registration form did not pass and is invalid (step 312), the web server 170 sends the client program an warning indicating that the submitted form is invalid, and the process goes back to step 302 for the person to correct the errors and resubmit the form.

If at step 312, the compliance server 178 determines that the submitted form meets all requirements and is valid, the system 100 then determines the user's category by checking if the user of the client program chooses to be registered as an investment user or a fund-seeking user (step 314). If the user of the client program chooses to be registered as an investment user, the system 100 then creates an investment user account in the investor database 188 of the administration server 174 (step 316), and the process goes to step 226. The user of the client program is now a user of the system 100, and may launch the client program 162 to log in to the system by providing a user name and password.

If, at the user category determination step 314, it is determined that the user of the client program chooses to be registered as a fund-seeking user, the system 100 then creates a fund-seeking user company account in the company database 190 of the administration server 174 (step 318), and the process goes to step 226.

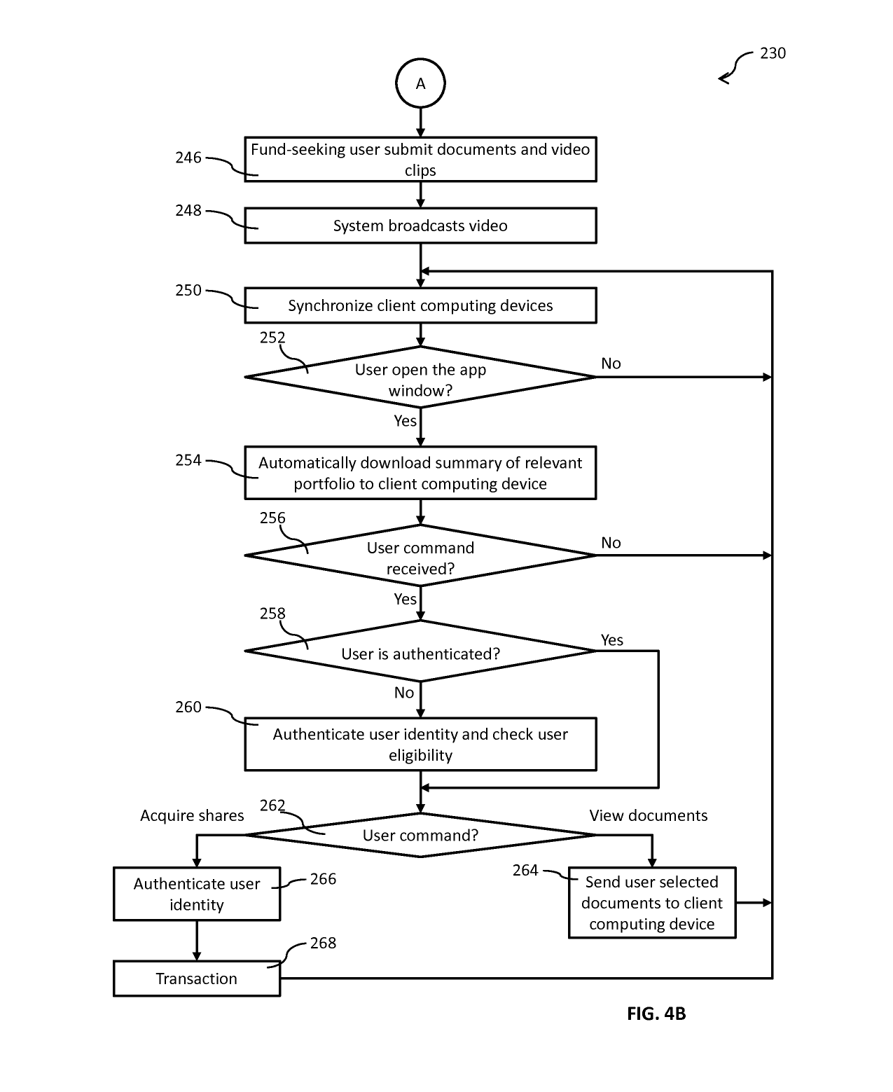

FIGS. 4A and 4B are a flowchart illustrating a process 230 for establishing investment transactions. At step 232, a user launches the client program on the user's client computing device 106. The client program then looks for any user credential stored on the client computing device 106 (step 234). If such a user credential is found, the client program loads the user credential (step 236), and the process goes to step 246. If at step 234, no user credential is found, the client program requests the user to login by asking for a user name and password (step 238). After the user logs-in, the process goes to the data uploading step 246.

At step 246, a fund-seeking user may log in to the system 100, and submit one or more fund-seeking video clips for television broadcast and company data 200. Here, a fund-seeking video clip for television broadcast may comprise the information of a single fund-seeking company. However, a fund-seeking video clip may also comprise the information of a plurality of fund-seeking companies. The submitted video clip is stored in the television server 166 for broadcasting under the television server's schedule. The submitted documents and a copy of the submitted video clip are stored in the content server 176 for investment users to review.

At this step, a fund-seeking user may also submit a fund-raising scheme defining the total number of shares to sell, and the price of each share. The fund-raising scheme may also include criteria such as the minimum amount of shares that an investment user has to buy. In this embodiment, the shares that are offered for sale have been vetted in the system through industry standard, due-diligence processes. Fund-seeking users have to agree to only make available shares of an agreed standard class, such that investors have assurance that shares being sold are those that have been deemed worthwhile.

When a fund-seeking user submits documents, the compliance server 178 checks whether the submitted documents meet relevant legislation and regulation requirements.

At step 248, the television server 166 broadcasts one or more fund-seeking video clips to television devices 164. Each of the one or more fund-seeking video clips is broadcasted at a scheduled date and time. The schedule server 168 communicates with the television server 166 to obtain a broadcast schedule of the fund-seeking video clips, and synchronizes the client program 162 of investment users by sending notifications when a fund-seeking video clip is currently in broadcast (step 250).

The system waits for user commands sent from the client program 162 of an investment user. If no user command is received (step 252), the process goes back to step 250. If a user command is received from the client program 162 of an investment user, the system 100 automatically downloads to the client computing device a summary, or portfolio, of the company whose fund-seeking video clip is currently playing on television, and displays the downloaded summary on the display of the client computing device (step 254). Then, the system checks if any user command has been received (step 256). If no user command has been received, the process goes to step 250. If a user command is received, the system further checks if the investment user has been authenticated (step 258). If the investment user has been authenticated, the process goes to step 262. If the investment user has not been authenticated, the system then authenticates the investment user's identity (step 260) by asking the investment user to enter his/her user name and password. Those skilled in the art appreciate that the system may alternatively authenticate investment user's identity by further asking some of investment user's investment or fund-seeking history, name, phone number, email, billing address, occupation and the like. After successfully authenticating the investment user's identity, at step 260, the system also verifies if the investment user is eligible for acquiring shares of the fund-seeking company in the video clip currently in broadcasting.

After user authentication and eligibility verification, the system checks the user command (step 262). If the user command is a command for viewing documents, the system then presents the investment user a list of one or more documents, and downloads the investment user selected documents to the investment user's client computing device (step 264). The process then returns to synchronizing client computing device 106 of step 250.

If at step 262, it is determined that the user command is a command for acquiring shares of a company, the system then once again authenticates the investment user's identity (step 266). If the investment user's identity is successfully authenticated, the system guides the investment user to establish a transaction to acquire shares of the desired company (step 268). The process then returns to synchronizing client computing device 106 of step 250.

With reference to FIG. 7, an example is shown of a client computing device 106 displaying a broadcast notification. The client computing device 106 typically comprises a camera 402, a display 404 and a home button 406. The display 404 displays a UI comprising a status bar 408 and a plurality of icons and thumbnails 410.

The schedule server 168 periodically communicates with the client program running in the client computing device 106 to notify the investment user regarding the broadcasting of fund-seeking video clips. When a fund-seeking video clip starts currently broadcasting in a television channel, the schedule server 168 sends each client program a push notification containing, e.g., the name of the video clip, and name of the fund-seeking company, the channel that the video clip is broadcasting, and the broadcast start time and duration of the video clips. As a result, a notification icon 412 is displayed in the status bar 408 of the UI on the display, indicating that a fund-seeking video clip regarding one or more fund-seeking companies is currently in broadcasting.

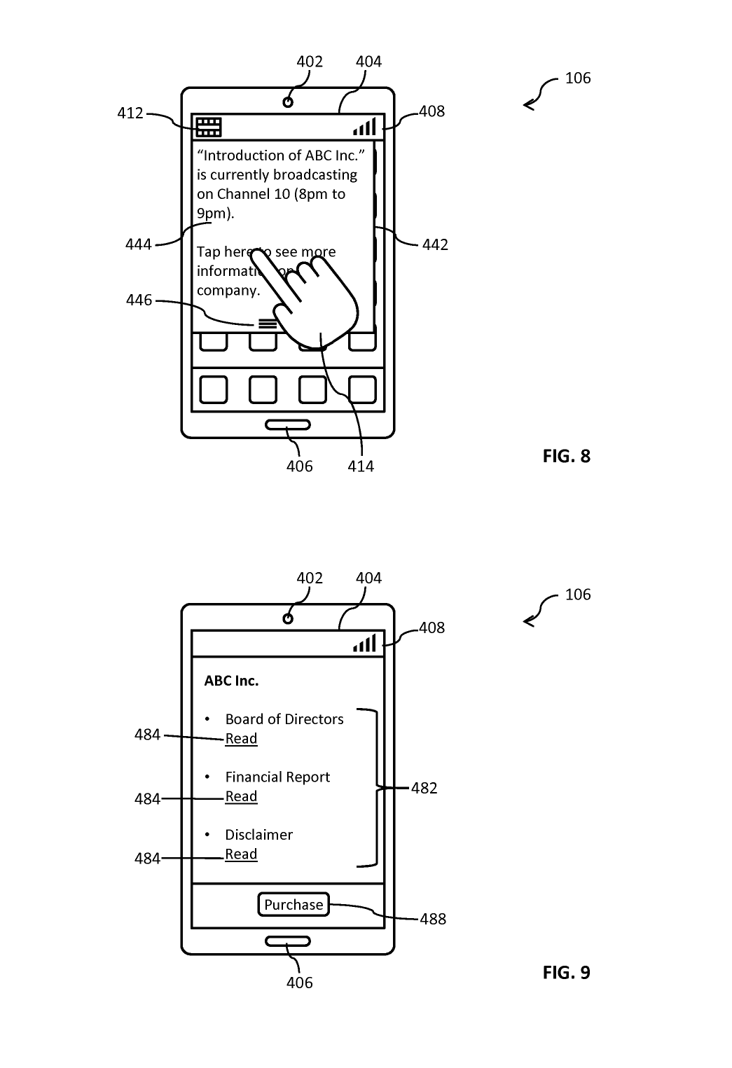

The investment user 414 may tap the notification icon 412 to view more detail. As shown in FIG. 8, a dialog 442 pops up on the UI of the client computing device 106 showing a message 444 and a close-dialog handle 446. The message 444 indicates, e.g., the name of the video clip, and name of the fund-seeking company, the channel that the video clip is broadcasting, and the broadcast start time and duration of the video clips. In the example shown in FIG. 8, the message 444 reads: “Introduction of ABC company is currently broadcasting on Channel 10 (8 pm to 9 pm). Tap here to see more information on this company.” The investment user 414 may turn on the television, and tune to Channel 10 to watch the video clip.

When watching the video clip, the investment user 414 may tap the notification dialog 442 display on his/her client computing device 106 to obtain more information regarding the ABC company, or may drag the handle 446 towards the top edge of the display 404 to close the notification dialog 442.

After the investment user 414 taps the notification dialog 442, a summary of the fund-seeking company is displayed on the display of the client computing device. As shown in FIG. 9, the summary displayed on the client computing device 106 includes a list of documents 482, each comprising a link 484 for downloading the document to the client computing device 106 and displaying it on the display 404 for the investment user to read. A “Purchase” button 490 is also shown on the display 404 of the client computing device 106 for the investment user to acquire shares of the fund-seeking company.

The investment user may slide a pointer, such as a pen tool or finger, towards the top or bottom of the display 404 to scroll the list of documents 482. If the investment user taps the link 484 of a document, the system then checks if the investment user has been authenticated (step 258 in FIG. 4), and, if not, authenticates the investment user's identity (step 260 in FIG. 4) by asking the investment user to enter his/her user name and password (not shown). After the investment user's identity is successfully authenticated, the system downloads the user-selected document from the content server 176 to the investment user's client computing device 106, and displays the downloaded document on the display 404 thereof (step 264 in FIG. 4).

The investment user may tap the “Purchase” button 490 to start a transaction for acquiring shares of the company currently being viewed. In response, the system again authenticates the investment user's identity (step 266 in FIG. 4) by asking the investment user to enter his/her user name and password (not shown). After the investment user's identity is successfully authenticated, the system establishes a share-acquiring transaction for the user (step 268 in FIG. 4).

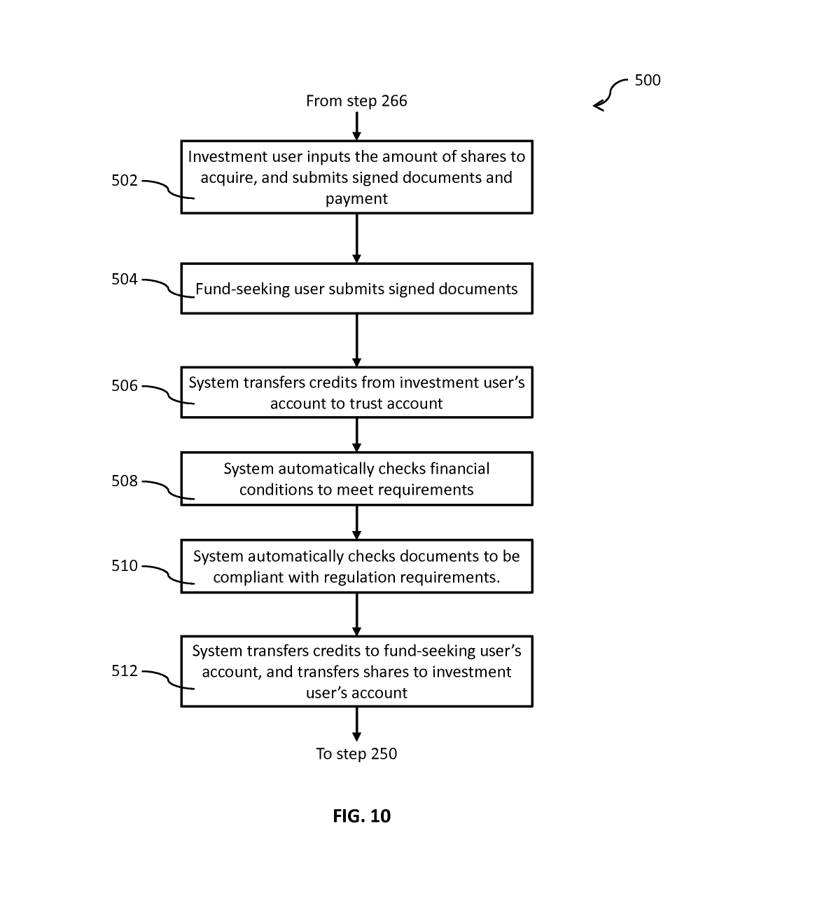

FIG. 10 illustrates additional detail 500 of the transaction step 268. At step 502, when an investment user decides to acquire some shares of a desired fund-seeking company, the investment user first submits a share-acquisition request by inputting, via a UI (not shown), the amount of shares to acquire, and submitting signed documents that the investment user has downloaded during review of the desired fund-seeking company (at step 264 of FIG. 4). At this step, the documents may be signed by embedding the investment user's digital signature, or manually signed and scanned into the system as a computer readable file such as an image or a PDF file. The investment user also submits payment necessary for acquiring the desired shares at this step.

The system then notifies the corresponding fund-seeking user of the share-acquisition request, and asks the fund-seeking user to sign necessary documents (step 504). After receiving signed documents from the fund-seeking user, the system transfers credits from investment user's account to a predetermined trust account (step 506). At step 508, the compliance server 178 then automatically checks if the financial conditions of both the investment user and the corresponding fund-seeking user meet predetermined requirements (if any), and if the payment is valid. Various financial systems can be engaged including the Automated Clearing House (ACH) Banking system. At step 510, the compliance server 178 further automatically checks if the documents signed by the investment user and the corresponding fund-seeking user meet legislation and regulation requirements, e.g., requirements of the U.S. Securities and Exchange Commission (SEC) and the U.S. federal and state legislations. At this step, the documents signed by the investment user and the fund-seeking user are made available to both parties. Optionally, the legal counsel of the service provider of the system is also involved to further verify that the documents signed by both parties and the payment are correct.

At step 512, the transaction server 182 transfers the payment held in the predetermined trust account in to the fund-seeking user's account, and issues share certificates to the investment user. The issued share certificates are recorded in the investment user's profile in the administration server.

Alternative embodiments are also available. For example, in an alternative embodiment, the system does not conduct an additional verification (step 310 of FIG. 5) during user registration.

In above embodiments, the schedule server 168 obtains broadcast schedule from the television server 166. In another embodiment, the schedule server 168 generates, under the instruction of one or more users of the system such as a television program planner, the broadcast schedule, and sends the generated broadcast schedule to the television server 166. The television server 166 receives the schedule therefrom, and broadcasts video clips according to the received broadcast schedule.

In yet another embodiment, the system does not utilize a schedule server 168. When the television server 166 broadcasts a fund-seeking-user-submitted video clip, an audio watermark, which is an encoded audio clip, is embedded therein. When running, the client program, installed on each client computing device 106, turns on the microphone of the client computing device 106 to seek an audio watermark. If an audio watermark is detected, the client program decodes the audio watermark to synchronize with the video clip in broadcasting, and notifies the user that further information regarding the fund-raising company in the video clip currently in broadcasting is available for review.

In still another embodiment, when the television server 166 broadcasts a fund-seeking-user-submitted video clip, a video watermark, which is an encoded video clip, is embedded therein. The client program installed on each client computing device 106, under the investment user's instruction, turns on the camera of the client computing device 106 to capture images of the television and detect the video watermark. If a video watermark is detected, the client program decodes the video watermark to synchronize with the video clip in broadcasting, and notifies the user that further information regarding the fund-raising company in the video clip currently in broadcasting is available for review.

Although in the above embodiments, an investment user has to go through identity authentication at step 266 of FIG. 4 before establishing a transaction (step 268 of FIG. 4), in an alternative embodiment, such an additional identity authentication of step 266 is not included in the process 240, and therefore, the investment user does not need to go through the additional identity authentication of step 266 before establishing a transaction.

Although in the above embodiments, the system comprises a television server for broadcasting television programs, in an alternative embodiment, the system obtains the broadcasting schedule of one or more television servers independent thereto using an appropriate means, such as via communication with the television servers, via communication with a computing device in a network of the television servers, or via manual input from a administrative user. The system stores the broadcasting schedule and uses it for synchronizing client computing devices thereof.

In the above embodiments, a user is categorized to an investment user or a fund-seeking user during registration. In an alternative embodiment, users are not categorized. A user may be a fund-seeking user when the user posts a business plan and/or a video clip for television broadcast. A user may also be an investment user when the user chooses to acquire securities from another user who has posted a business plan and/or a video clip for television broadcast.

What is claimed is:

1. A computerized method for establishing a transaction for transferring security shares in exchange of payment between a first user and a second user, said method comprising:
storing at least one first document relevant to a business plan of the first user;
broadcasting a video clip describing said business plan as a television program according to a predetermined broadcast schedule;
synchronizing, at the time said video clip is broadcasting, a computing device of the second user with the video clip on broadcast;
in response to a request received from the computer device of the second user, authenticating the second user and determining the eligibility of the second user based on predefined criteria;
transmitting at least one of the at least one first document to the computer device of the second user;
receiving, from second user, a request for the acquisition of security shares offered from the first user, at least one document having a signature of the second user and a payment;
establishing a transaction between the first and second users for transferring security shares from the first user to the second user and for transferring payments from the second user to the first user.

2. A method of claim 1 wherein said synchronizing further comprises:
sending, at the time said video clip is broadcasting, a synchronization message to the computing device of the second user for notifying the computing device that the video clip is on broadcast.

3. A method of claim 2 wherein said synchronization message is sent from a server computer.

4. A method of claim 1 wherein said establishing a transaction further comprises:
automatically checking the at least one document to verify whether the at least one document is compliant with a set of predefined rules.

5. A method of claim 5 wherein said predefined rules is defined in a legislation.

6. A method of claim 1 wherein said checking the at least one document further comprises:
automatically verifying that the at least one document has a signature of the second user.

7. A computer system for establishing a transaction for transferring security shares in exchange of payment between a first user and a second user, said system comprising:
at least one server;
at least one storage functionally coupling to said server;
a plurality of client computing devices functionally coupling to said server; said server executing computer readable code for
storing, in said storage, at least one first document relevant to a business plan of the first user;
storing, in said storage, a broadcast schedule of a video clip broadcasting in a television channel as a television program;
synchronizing, at the time said video clip is broadcasting, a client computing device of the second user with the video clip on broadcast;
in response to a request received from the client computer device of the second user, authenticating the second user and determining the eligibility of the second user based on predefined criteria;
transmitting, from said storage, at least one of the at least one first document to the client computer device of the second user;
receiving, from second user, a request for the acquisition of security shares offered from the first user, at least one document having a signature of the second user and a payment;
establishing a transaction between the first and second users for transferring security shares from the first user to the second user and for transferring payments from the second user to the first user.

8. A computer system of claim 7 wherein said server further executes computer readable code for:
broadcasting the video clip according to the broadcast schedule;

9. A computer system of claim 7 wherein said synchronizing further comprises:
sending, at the time said video clip is broadcasting, a synchronization message to the computing device of the second user for notifying the computing device that the video clip is on broadcast.

10. A computer system of claim 7 wherein said establishing a transaction further comprises:
automatically checking the at least one document to verify whether the at least one document is compliant with a set of predefined rules.

11. A computer system of claim 10 wherein said predefined rules is defined in a legislation.

12. A computer system of claim 7 wherein said checking the at least one document further comprises:
automatically verifying that the at least one document has a signature of the second user.

13. A computerized method for establishing a transaction for transferring security shares in exchange of payment between a first user and a second user, said method comprising:
storing at least one first document relevant to a business plan of the first user;
storing a broadcast schedule of a video clip broadcasting in a television channel as a television program;
synchronizing, at the time said video clip is broadcasting, a computing device of the second user with the video clip on broadcast;
in response to a request received from the computer device of the second user, authenticating the second user and determining the eligibility of the second user based on predefined criteria;
transmitting at least one of the at least one first document to the computer device of the second user;
receiving, from second user, a request for the acquisition of security shares offered from the first user, at least one document having a signature of the second user and a payment;
establishing a transaction between the first and second users for transferring security shares from the first user to the second user and for transferring payments from the second user to the first user.

14. A computerized method of claim 13 further comprising:
broadcasting the video clip according to the broadcast schedule.

15. A computer-readable storage device comprising computer-executable instructions for establishing a transaction for transferring security shares in exchange of payment between a first user and a second user, wherein the instructions, when executed, cause at lease one processor to perform actions comprising:
storing at least one first document relevant to a business plan of the first user;
storing a broadcast schedule of a video clip broadcasting in a television channel as a television program;
synchronizing, at the time said video clip is broadcasting, a computing device of the second user with the video clip on broadcast;
in response to a request received from the computer device of the second user, authenticating the second user and determining the eligibility of the second user based on predefined criteria;
transmitting at least one of the at least one first document to the computer device of the second user;
receiving, from second user, a request for the acquisition of security shares offered from the first user, at least one document having a signature of the second user and a payment;
establishing a transaction between the first and second users for transferring security shares from the first user to the second user and for transferring payments from the second user to the first user.
